(19) United States
(12) Patent Application Publication
(10) Pub. No.: US 2020/0168111 A1
(43) Pub. Date: May 28, 2020

(54) LEARNING METHOD FOR A NEURAL NETWORK EMBEDDED IN AN AIRCRAFT FOR ASSISTING IN THE LANDING OF SAID AIRCRAFT AND SERVER FOR IMPLEMENTING SUCH A METHOD

(71) Applicant: THALES, Courbevoie (FR)

(72) Inventors: Yoan VEYRAC, MERIGNAC (FR); Patrick GARREC, MERIGNAC (FR); Pascal CORNIC, BREST (FR)

(21) Appl. No.: 16/691,031

(22) Filed: Nov. 21, 2019

(30) Foreign Application Priority Data
Nov. 22, 2018 (FR) 1871698

(51) Int. Cl. G08G 5/02; G05D 1/10; G06N 3/08; G06T 17/05

(52) U.S. Cl. CPC G08G 5/025; G06T 17/05; G06N 3/08; G05D 1/101

(57) ABSTRACT

The method uses a fleet of aircraft being equipped with at least one radar sensor, it includes at least: a step of collective collection of radar images by a set of aircraft (A₁, . . . A_{N}) of the fleet, the radar images being obtained by the radar sensors of the aircraft (A₁, . . . A_{N}) in nominal landing phases on the runway, a step wherein each image collected by an aircraft is labelled with at least information on the position of the runway relative to the aircraft, the labelled image being sent to a shared database and stored in the database; a step of learning by a neural network of the runway from the labelled images stored in the shared database, at the end of the step the neural network being trained; a step of sending of the trained neural network to at least one of the aircraft (A₁).

### CROSS-REFERENCE TO RELATED APPLICATIONS

This application claims priority to foreign French patent application No. FR 1871698, filed on Nov. 22, 2018, the disclosure of which is incorporated by reference in its entirety.

### FIELD OF THE INVENTION

The present invention relates to a learning method for a neural network embedded in an aircraft for assisting in the landing of said aircraft. The invention relates also to a server for implementing such a method.

The technical field of the invention is that of the detection and the recognition of an environment relative to the position of an observer. The main field of operation is that of the radar, for landing assistance applications. This invention more specifically targets the “EVS” (Enhanced Vision System) landing assistance systems. The invention could be applied to other sensors (for example optical or electro-optical).

### BACKGROUND

The invention addresses in particular the problem of assisting in the landing of aircraft on a landing runway, in conditions of reduced visibility, in particular because of difficult weather conditions, for example in case of fog. The standards impose rules for obtaining visibility during the landing phase. These rules are reflected by decision thresholds which refer to the altitude of the aeroplane during its descent phase. At each of these thresholds, identified visual markers must be obtained to continue the landing manoeuvre, without which it must be aborted. The aborted landing manoeuvres represent a real problem for air traffic management and for flight scheduling. The capacity to be able to land at destination must be estimated before take-off on the basis of weather forecasts, which are more or less reliable, and, if necessary, fallback solutions must be provided.

The problem of the landing of aircraft in conditions of reduced visibility has been the subject of the development of multiple techniques which are currently used.

One of these techniques is the instrument landing system (ILS). The ILS system relies on radio frequency equipment installed on the ground, at the landing runway, and a compatible instrument placed onboard the aircraft. The use of such a guidance system requires expensive equipment and specific qualification of the pilots. Also, it cannot be installed on all airports. It requires maintenance by aeroplanes used to calibrate the system. This system is not generalised and it is currently being withdrawn from operation.

Another alternative is landing assistance by GPS. Although this has sufficient accuracy, the reliability of this solution is too low since it can easily—deliberately or not—be subject to scrabbling. Its integrity is not guaranteed.

Finally, an augmented vision technique is also employed (Enhanced Vision System, EVS). The principle is to use more powerful sensors than the eye of the pilot in degraded weather conditions, and to embed the information collected in the field of view of the pilot, by means of a head-up display or on the visor of a headset worn by the pilot. This technique relies essentially on the use of sensors to detect the radiation of the lamps disposed along the runway and on the approach ramp. The incandescent lamps produce visible light but they also emit in the infrared range. Sensors in the infrared range make it possible to detect these radiations and the detection range is better than that of the human eye in the visible range, in degraded weather conditions. A visibility enhancement therefore makes it possible, to a certain extent to improve the approach phases and to limit the aborted approaches. However, this technique relies on the stray infrared radiation from the lamps present in the vicinity of the runway. In the interests of durability of the lamps, the current trend is to replace incandescent lamps with LED lamps. The latter have a narrower spectrum in the infrared range. A collateral effect is therefore to provoke a technical obsolescence of the EVS systems based on infrared sensors.

An alternative to infrared sensors is to obtain images by a radar sensor, in a centimetric or millimetric band. Some frequency bands chosen outside of the water vapour absorption peaks exhibit a very low sensitivity to difficult weather conditions. Such sensors therefore make it possible to produce an image through fog for example. However, even if these sensors have a fine distance resolution, they have a much coarser angular resolution than the optical solutions. The resolution is directly linked to the size of the antennas used, and it is often too coarse to obtain an accurate positioning of the landing runway at a sufficient distance to form adjustment manoeuvres.

There is therefore a need for new technical solutions that make it possible to guide the approach manoeuvre with a view to a landing in reduced visibility conditions.

### SUMMARY OF THE INVENTION

One aim of the invention is notably to allow such guidance in reduced visibility conditions. To this end, the subject of the invention is a learning method for a neural network embedded in an aircraft for assisting in the landing of said aircraft on at least one given runway, said neural network positioning said aircraft relative to the runway, said method using a fleet of aircraft being equipped at least with one radar sensor and comprising at least:
a step of collective collection of radar images by a set of aircraft of said fleet, said radar images being obtained by the radar sensors of said aircraft in nominal landing phases on said runway, a step in which each image collected by an aircraft is labelled with at least information on the position of said runway relative to said aircraft, said labelled image being sent to a shared database and stored in said database;
a step of learning by a neural network of said runway from the labelled images stored in said shared database, at the end of said step said neural network being trained;
a step of sending of said trained neural network to at least one of said aircraft.

In a particular implementation, said neural network transmits, to a display and/or control means, the trajectory of said aircraft.

Said database comprises, for example, labelled radar images specific to several landing runways, the labelled images comprising identification of the imaged runway.

Each labelled image comprises, for example, the identification of the aircraft having transmitted said image.

In a particular implementation:
the radar images being affected by a bias specific to the installation of said radar sensor on each aircraft, said bias is estimated for each radar image before it is stored in said database, the estimated bias being stored with said image; the trained neural network being transmitted to a given aircraft with the estimated bias specific to that aircraft.

The estimation of said bias for a given aircraft and for a given runway is, for example, produced by comparison between at least one radar image obtained by the radar sensor with which said aircraft is equipped and a reference image of said runway and of its environment. Said reference image consists, for example, of a digital terrain model.

The means for transmitting said labelled images between an aircraft and said database are made, for example, by means of the radar sensor with which said aircraft is equipped, the transmissions being performed by modulation of the data forming said images on the radar wave.

In a particular implementation, an aircraft carrying said radar sensor, the labelling of said images comprises at least one of the following indications:
date of acquisition of the image relative to the moment of touchdown of said carrier on the runways;
location of said carrier at the moment of image capture:
absolute: GPS position;
relative with respect to the runway: inertial unit;
altitude of said carrier;
attitude of said carrier;
speed vector of said carrier (obtained by said radar sensor as a function of its ground speed);
acceleration vector of said carrier (obtained by said radar sensor as a function of its ground speed);
position, relative to said carrier, of the runway and of reference structures obtained by accurate location optical means.

Said database is, for example, updated throughout the nominal landings performed by said aircraft on at least said runway.

Another subject of the invention is a server comprising a database for the learning of an embedded neural network for the implementation of the method as described previously, said server being capable of communicating with aircraft. Said neural network is, for example, trained in said server, the trained network being transmitted to at least one of said aircraft.

### BRIEF DESCRIPTION OF THE DRAWINGS

Other features and advantages of the invention will become apparent from the following description, given in light of the attached drawings which represent:

FIG. 1, an exemplary embodiment of a landing assistance device used by the method according to the invention;

FIG. 2, an illustration of an operational landing phase performed using the device of FIG. 1;

FIG. 3, a representation of a neural network allowing the positioning of a carrier relative to a given runway from a sequence of radar images;

FIG. 4, an illustration of the principle of collective learning according to the invention;

FIG. 5, a chain of operation of the learning data and of restoration of trained neural networks, in the implementation of the invention;

FIG. 6, a representation of an example of estimation of a bias linked to an aircraft.

### DETAILED DESCRIPTION

To guide an aircraft to rejoin a runway, the invention advantageously combines a radar sensor, with very little sensitivity to weather conditions, and a neural network, both embedded in the aircraft. This neural network shares a learning base of radar images with neural networks of other aircraft, this base being updated collectively by these aircraft by a stream of radar images taken in landing phases. The use of the complete environment of an airport and of the landing runway allows for an accurate positioning using the embedded neural network, trained over several landings.

The first step is to describe the part of the landing assistance system for guiding an aircraft. The description is given for rejoining a given runway.

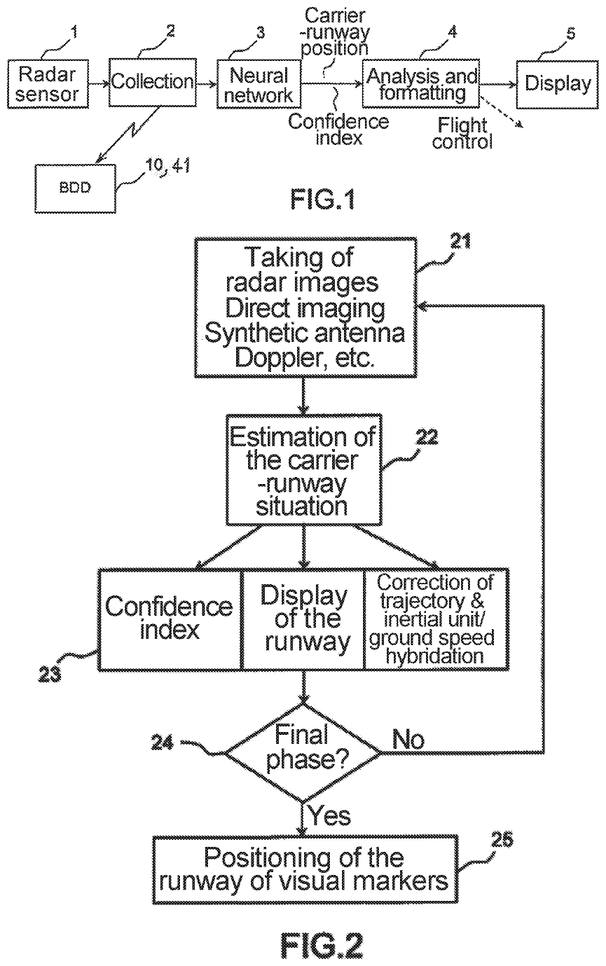

FIG. 1 presents, in accordance with the invention, a landing assistance device of an aircraft based on detection and positioning of the landing runway relative to that aircraft. It comprises at least:
a radar sensor 1 carried by said aircraft, whose function notably is to obtain radar images of the landing runways;
a functional block 2 for collecting embedded radar images, performing at least the labelling and the storing of radar images obtained by the sensor 1, the stored images being then transmitted to a database 10 shared with other aircraft as will be described hereinbelow;
a functional block 3 comprising a neural network, embedded in the aircraft, the neural network being trained from the collection of radar images, that is to say from the radar images obtained during nominal landings (in clear weather) and whose function is to estimate the position of the landing runway relative to the carrier using the radar images obtained in real time by the radar sensor 1 (that is to say obtained during the current landing), these images being stored in a database associated with the collection system 2;
another functional block 4, also embedded, performing the analysis and the formatting of the data obtained from the neural network making it possible to format these data with an appropriate interface, this interface being able to allow the display of the runway or of the symbols representing it, even provide flight controls making it possible to rejoin the nominal landing trajectory.

The device comprises, for example, a system 5 for displaying the runway, visual mark and relevant navigation data incorporated in the field of view of the pilot via a head-up display (HUD) system or a headset, any other display system being possible.

The collection block, the neural network and the block 4 for analysing the data are, for example, incorporated in the flight computer of the aircraft.

Once labelled, the radar images are used by the neural network 3 as will be described hereinbelow. They are used to train the latter. More specifically, the neural network performs the learning of the landing runway from all the images stored and labelled in the learning base. Once trained, the neural network 3 is capable, from a series of radar images, of positioning the runway and its environment with respect to the carrier, more particularly of positioning the landing point. The images input to the neural network are the images taken by the radar 1 in the current landing phase.

It is then possible, for the functional block 4, to estimate and correct the deviation of the corresponding trajectory (trajectory of the carrier in the current landing) relative to a nominal landing trajectory. It is also possible to display the runway in the field of view of the pilot by means of the display system 5.

The radar sensor 1 operates, for example, in centimetric band or in millimetric band, it makes it possible to position the carrier with respect to a landing runway on which the latter wants to land, independently of the conditions of visibility of the pilot. The radar images obtained can be direct radar images or images of SAR (Synthetic Aperture Radar) type. The latter make it possible to refine the angular accuracy while benefitting from the changing viewing angle from the movement of the carrier.

The radar images are obtained by the radar sensor 1 in each landing phase, which makes it possible to continuously enrich the database of radar images. As indicated previously, the acquisition of these radar data is performed during nominal landing manoeuvres, in clear weather, during the day or at night. This acquisition is also done in different aerology and manoeuvre conditions (different types of winds, different skewed arrivals, different approach slopes), the information on all these conditions being contained in the labelling of the images. Once the landing is finished, the radar data obtained during the landing phase are recorded in the database and labelled as forming part of a nominal landing manoeuvre. The labelling comprises at least this nominal landing information, but it can advantageously be extended to the following additional information, depending on the availability on the carrier:
date of acquisition of the image relative to the moment of touchdown of the wheels of the carrier on the runways;
location of the carrier at the moment of image capture:
absolute: GPS position;
relative with respect to the runway: inertial unit;
altitude of the carrier;
attitude of the carrier;
speed vector of the carrier (obtained by the radar 1 as a function of its ground speed);
acceleration vector of the carrier (obtained by the radar 1 as a function of its ground speed);
position, relative to the carrier, of the runway and of reference structures obtained by accurate location optical means.

FIG. 2 illustrates the operational operating method implemented by the device illustrated by FIG. 1 for assisting in the landing of an aircraft. This method comprises the steps described hereinbelow with respect to FIG. 2, for a given landing runway.

Two preliminary steps that are not represented concern the collection of the images and the learning of the runway from the collected images.

A first step 21 performs the taking of a first series of radar images, these images being radar images or SAR images obtained by the radar sensor 1 embedded on the aircraft. Each radar image is labelled in accordance with the images already recorded in the collection system 2.

In the second step 22, the situation of the carrier relative to the runway and to its environment is estimated by means of the neural network, from the series of radar images obtained. It is possible to provide a series consisting of a single radar image, the estimation being able to be performed from a single image.

In a third step 23, the estimation supplied by the neural network 3 is analysed, this analysis being performed using the functional block 4 for example. The latter supplies the data formatting for the display (performed by the display system 5) and to provide the flight controls that make it possible to correct the trajectory. It also makes it possible to present, in a useable form, the confidence indicator calculated by the neural network.

At the end of this third step 24, if the aeroplane is not in final landing phase (that is to say at the point of rejoining the landing runway), the method loops back to the first step 21 where a new series of radar images is obtained. Otherwise, if the aeroplane is in final landing phase, the method arrives 25 at the final positioning of the aircraft with respect to the runway with the definitive landing trajectory.

The landing method used by the invention therefore relies on the learning of the landing sequence and of the associated radar images. This method requires learning data (the labelled radar images) to operate appropriately. In particular, the accuracy of the positioning depends on the number of learning data available and updated.

The method according to the invention uses several aircraft each equipped with the same landing assistance device as that described with respect to FIGS. 1 and 2. The radar sensor 1 makes it possible to take images of the environment of the runway and to position the carrier (position, speed and altitude) with respect to the runway using these images by means of the neural network 3.

That requires a prior learning step, during which the radar images obtained during nominal landing phases are labelled with the data available during the landing, as described previously. These labelled images are used to train the neural network of the landing assistance device. Once trained, the neural network makes it possible, using the images obtained during a landing in conditions of reduced visibility, to obtain the relative positioning of the carrier with respect to the runway. The operational operation has been described with respect to FIG. 2. The accuracy of this positioning depends on the quality of the learning performed, and in particular on the number of images available for this learning. The higher this number is, the better the quality of learning is. According to the invention, the database of radar images 10 is enriched collectively by several aircraft. More specifically, for a given landing runway, this base is enriched with images obtained during the landing phases of several aircraft. One and the same base can contain images specific to several runways.

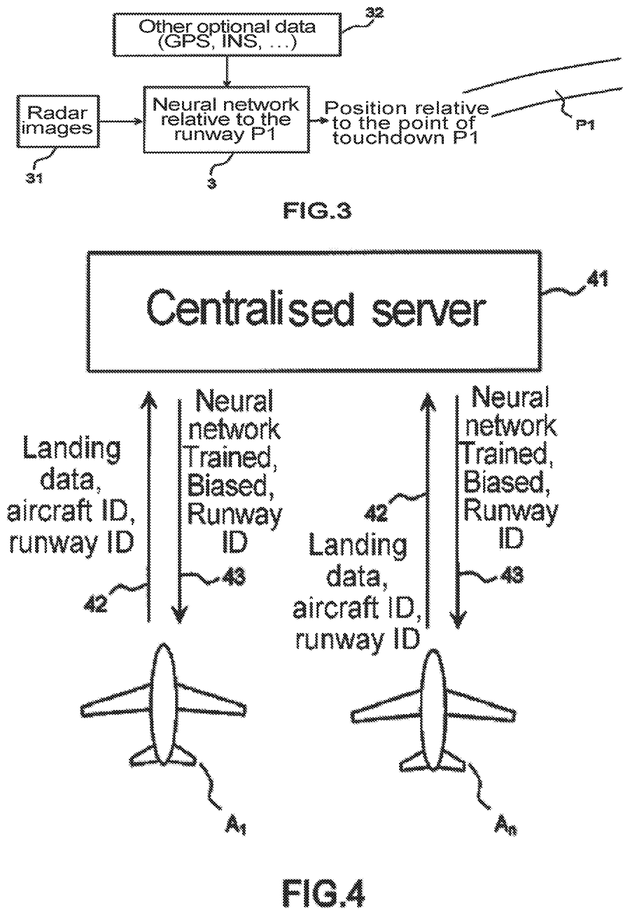

FIG. 3 represents a neural network allowing the positioning of the carrier with respect to a runway P1 from a sequence of radar images. More particularly, FIG. 3 presents the inputs and outputs of this neural network 3 in its use during a landing on this runway P1.

This network takes input radar images 31, and optionally data 32 originating from additional sensors, such as GPS for example. Using these data, the neural network establishes the positioning of the carrier with respect to the runway. This positioning includes the attitude of the carrier. It can be enriched with its speed and with the estimated point of touchdown of the wheels.

FIG. 4 illustrates more particularly the method according to the invention. The invention proposes a collective learning method allowing each embedded landing assistance device to have a reference base that is solid, proven and kept up to date for at least one landing runway where the carrier is required to set down. This reference base can advantageously comprise the learning data of several runways.

The method according to the invention uses a fleet of N aircraft A1, . . . AN each equipped with a landing assistance device according to FIG. 1. At each landing phase, each device sends 42 the landing data, including the labelled images, to a centralised server 41, for example situated on the ground, this server containing the database 10. Concurrently with the labelled images, the device sends an identifier of the aircraft A1, . . . AN and an identifier of the landing runway. The transmission of these data is done by means of a suitable communication system.

This communication means can be incorporated in the radar sensor 1 of each embedded device, the data transmissions being performed by modulation of the data on the radar wave. In other words, the modulation of the transmitted radar wave codes the transmitted data.

This server uses these labelled data in order to train neural networks associated respectively with the corresponding runways. The training (or learning) of the neural networks is done from the data stored in the server 41, the learning consisting in particular in learning at least one landing trajectory on the identified runway.

The server sends 43, to the different aircraft, the trained neural networks (forming the functional block 3 in each landing assistance device).

More specifically in this step of sending 43 of a trained neural network to an aircraft, the neural network is transmitted to a means for controlling the trajectory of this aircraft, this means being typically the functional block 3 then the formatting and analysis block 4 whose operations have been described previously. This control means allows the display of the trajectory for assisting in the piloting or directly makes it possible to control and correct the trajectory of the aircraft.

Given that the different radar sensors 1 can exhibit a bias, notably in the mounting plane on installation in the aircraft, provision is made, according to the invention, to compensate these different biases.

FIG. 5 illustrates the learning of the neural network corresponding to a runway P1, by taking into account the bias linked to an aircraft A1. The learning data originating from the aircraft A1 after a landing on the runway P1 are sent to the centralised server 41. The bias linked to the aircraft A1 is estimated by a processing means 51 located in the server 41. This bias estimation 51 is performed before the data incorporate the learning database 10 of the runway P1. This step makes it possible to normalise the data obtained from the different aircraft and to effectively effect convergence of the learning of the neural network associated with this runway P1 implemented in a module 300. The trained and normalised network is then transmitted to the different aircraft, after application 52 of a corrective bias relative to each aircraft.

With this neural network, each aircraft has a landing assistance function on an extended database which advantageously offers a good accuracy by virtue of the pooling of the data.

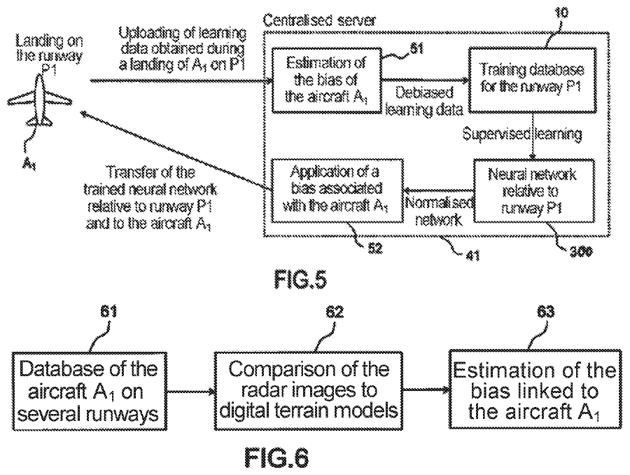

FIG. 6 illustrates an example of estimation of the bias linked to each aircraft. Other methods can be used.

In the example of FIG. 4, the landing data (labelled radar images) sent by the aircraft A1 relative to the landings on the different runways used are aggregated in a memory 61. These radar images are compared 62 to reference images, each of these reference images being specific to a runway and to its environment. These images include, for example, constructions and infrastructures. The reference images are, for example, digital terrain models (MNT), and can be digital elevation models when they include the constructions and the infrastructures.

This comparison 62 between the labelled radar images (labelled notably with the position of the aircraft) and the reference images makes it possible, for each aircraft A1, . . . AN, to estimate 63 the bias between the image taken by the radar sensor and the point of view of the aircraft projected into the reference images, for example, into the digital terrain model. The main bias is linked to the mounting plane of the radar sensor and it leads to a systematic angular error with respect to a normalised reference frame linked to the axes of the aircraft. The cross-referencing of the data relative to several runways enhances the estimation of this systematic error which can then be finely corrected.

Advantageously, the invention makes it possible to produce a collective database for the learning of the neural networks. A larger dataset is thus obtained which enhances the quality of the learning, in order to achieve a good accuracy of positioning of the runways with respect to the aircraft. In particular, an aircraft landing for the first time on a runway benefits from the collective experience, while taking account of the features specific to its sensor.

Again advantageously, the landing by means of a device according to the invention is particularly robust to the random variations of the environment, for example the presence of vehicles or of seasonal vegetation, which pose problems to fixed algorithms. Furthermore, the invention adapts to the ongoing variations of the environment, such as new constructions or infrastructures for example, by incorporating these elements in the learning base.

1. A learning method for a neural network embedded in an aircraft (A1) for assisting in the landing of said aircraft on at least one given runway (P1), said neural network establishing the positioning of said aircraft relative to said runway, wherein, using a fleet of aircraft being equipped at least with one radar sensor, said method comprises at least:
a step of collective collection of radar images by a set of aircraft (A₁, . . . A_{N}) of said fleet, said radar images being obtained by the radar sensors of said aircraft (A₁, . . . A_{N}) in nominal landing phases on said runway, a step wherein each image collected by an aircraft is labelled with at least information on the position of said runway (P1) relative to said aircraft, said labelled image being sent to a shared database and stored in said database;
a step of learning by a neural network of said runway from the labelled images stored in said shared database, at the end of said step said neural network being trained;
a step of sending of said trained neural network to at least one of said aircraft (A₁).

2. The method according to claim 1, wherein said neural network transmits, to a display and/or control means, the trajectory of said aircraft.

3. The method according to claim 1, wherein said database comprises labelled radar images specific to several landing runways, the labelled images comprising identification of the imaged runway.

4. The method according to claim 1, wherein each labelled image comprises the identification of the aircraft having transmitted said image.

5. The method according to claim 4, wherein:
the radar images being affected by a bias specific to the installation of said radar sensor on each aircraft, said bias is estimated for each radar image before it is stored in said database, the estimated bias being stored with said image;
the trained neural network being transmitted to a given aircraft with the estimated bias specific to that aircraft.

6. The method according to claim 1, wherein the estimation of said bias for a given aircraft (A₁) and for a given runway is produced by comparison between at least one radar image obtained by the radar sensor with which said aircraft is equipped and a reference image of said runway and of its environment.

7. The method according to claim 6, wherein said reference image consists of a digital terrain model.

8. The method according to claim 1, wherein the means for transmitting said labelled images between an aircraft and said database are made by means of the radar sensor with which said aircraft is equipped, the transmissions being performed by modulation of the data forming said images on the radar wave.

9. The method according to claim 1, wherein for an aircraft carrying said radar sensor, the labelling of said images comprises at least one of the following indications:
date of acquisition of the image relative to the moment of touchdown of said carrier on the runways;
location of said carrier at the moment of image capture:
absolute: GPS position;
relative with respect to the runway: inertial unit;
altitude of said carrier;
attitude of said carrier;
speed vector of said carrier (obtained by said radar sensor as a function of its ground speed);
acceleration vector of said carrier (obtained by said radar sensor as a function of its ground speed);
position, relative to said carrier, of the runway and of reference structures obtained by accurate location optical means.

10. The method according to claim 1, wherein said database is updated throughout the nominal landings performed by said aircraft on at least said runway.

11. A server, wherein it comprises a database for the learning of an embedded neural network for the implementation of the method according to claim 1, said server being capable of communicating with aircraft (A₁, . . . A_{N}).

12. The server according to claim 11, wherein said neural network is trained in said server, the trained network being transmitted to at least one of said aircraft.
